(19) United States
(12) Patent Application Publication
(10) Pub. No.: US 2023/0095838 A1
(43) Pub. Date: Mar. 30, 2023

(54) TIN SNIPS WITH BLADE BYPASS CALIBRATOR

(71) Applicant: APEX BRANDS, INC., Apex, NC (US)

(72) Inventor: Jeromy Higgins, Apex, NC (US)

(21) Appl. No.: 17/759,695

(22) PCT Filed: Jan. 21, 2021
(86) PCT No.: PCT/US2021/014303

§ 371 Date: Jul. 28, 2022

Related U.S. Application Data
(60) Provisional application No. 62/966,788, filed on Jan. 28, 2020.

(51) Int. Cl. B23D 29/02

(52) U.S. Cl. CPC B23D 29/026

(57) ABSTRACT

An example tin snip tool includes a first blade assembly including a first blade and the second blade assembly including a second blade. The example tin snip tool may also include a bolt configured to provide a pivot point that couples the first blade assembly to the second blade assembly and permits at least a portion of the first blade to bypass a portion of the second blade during a cutting operation, and a blade bypass calibrator including a movable adjustor member coupled to the first blade assembly and configured to contact the second blade assembly when the tin snip tool is in a closed position. An extension length of the adjustor member may define a blade bypass angle defined between a first blade tip and a second blade tip when the tin snip tool is in the closed position.

### TECHNICAL FIELD

Example embodiments generally relate to hand tools, and in particular tin snip tools.

### BACKGROUND

Many tin snips include cutting blades that cross over each other or overlap when performing a cutting operation. In some instances, this overlapping of the cutting blades can cause bending and unintended damage to the material forward of the current cutting operation when the tin snips are moved into a closed position. Such bending and damage to the material can be particularly problematic for thin, but malleable materials such as thin aluminum. More experienced metal workers may be aware of this potential for damaging the material and can take care to avoid such bending and damage. However, less experienced metal workers may not appreciate the potential to cause such damage and may inadvertently damage the material resulting in the need for rework, thereby causing waste and inefficiency. As such, there is a need for a solution to prevent or inhibit the ability to cause such inadvertent bending and damage to a material during a cutting operation with tin snips.

### BRIEF SUMMARY OF SOME EXAMPLES

An example tin snip tool is provided. The example tin snip tool may comprise a first blade assembly comprising a first blade having a first blade tip, a second blade assembly comprising a second blade having a second blade tip, a bolt configured to provide a pivot point that couples the first blade assembly to the second blade assembly and permits at least a portion of the first blade to bypass a portion of the second blade during a cutting operation, and a blade bypass calibrator comprising a movable adjustor member coupled to the first blade assembly and configured to contact the second blade assembly when the tin snip tool is in a closed position. An extension length of the adjustor member may define a blade bypass angle defined between the first blade tip and the second blade tip when the tin snip tool is in the closed position.

Another example tin snip tool is provided. The example tin snip tool may comprise a first blade assembly comprising a first blade having a first blade tip disposed at a forward end of the tin snip tool and a first handle disposed at a rearward end of the tin snip tool, a second blade assembly comprising a second blade having a second blade tip disposed at the forward end of the tin snip tool and a second handle disposed at the rearward end of the tin snip tool, a bolt configured to provide a pivot point that couples the first blade assembly to the second blade assembly and permits at least a portion of the first blade to bypass a portion of the second blade during a cutting operation, and a blade bypass calibrator comprising a movable adjustor member. The blade bypass calibrator may be disposed forward of the first handle and reward of the bolt. The adjustor member may be coupled to the first blade assembly and configured to contact the second blade assembly when the tin snip tool is in a closed position. An extension length of the adjustor member may define a blade bypass angle defined between the first blade tip and the second blade tip when the tin snip tool is in the closed position.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a side view of an example tin snip tool with a blade bypass calibrator and an adjustor member in a retracted position according to some example embodiments;

FIG. 2 illustrates a side view of a tin snip blade according to some example embodiments;

FIG. 3A illustrates a top view of a first blade assembly according to some example embodiments;

FIG. 3B illustrates a top view of a second blade assembly according to some example embodiments;

FIG. 4 illustrates a zoomed, perspective view of a blade bypass calibrator with an adjustor member removed according to some example embodiments;

FIG. 5 illustrates a zoomed, side view of a blade bypass calibrator with an adjustor member in a retracted position according to some example embodiments;

FIG. 6 illustrates a side view of a tin snip blade with an outline of another complementary tin snip blade and a positive blade bypass angle according to some example embodiments;

FIG. 7 illustrates a front view of a blade tip region taken at A-A of FIG. 1 and illustrating overlapping blade tips according to some example embodiments;

FIG. 8 illustrates a side view of an example tin snip tool with a blade bypass calibrator and an adjustor member in an extended position according to some example embodiments;

FIG. 9 illustrates a zoomed, side view of a blade bypass calibrator with an adjustor member in an extended position according to some example embodiments;

FIG. 10 illustrates a side view of a tin snip blade with an outline of another complementary tin snip blade defining zero-degree blade bypass angle according to some example embodiments;

FIG. 11 illustrates a front view of a blade tip region taken at B-B of FIG. 8 and illustrating non-overlapping blade tips according to some example embodiments;

FIG. 12 illustrates a side view of a tin snip blade with an outline of another complementary tin snip blade defining a negative blade bypass angle according to some example embodiments; and

FIG. 13 illustrates a side view of an example tin snip tool with another example blade bypass calibrator and an adjustor member in an extended position according to some example embodiments

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability, or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

According to some example embodiments, tin snips or a tin snip tool are provided that include an integrated blade bypass calibrator that is configured to allow a user to set an amount of blade bypass (or no blade bypass) when the tin snip tool is in a closed position (i.e., cutting blades are fully closed). In this regard, the blade bypass calibrator may include an adjustor member that is coupled to one of the two halves (i.e., blade assemblies) of the tin snip tool. The adjustor member may be movable by a user to set an extension length of the adjustor member. The adjustor member may be configured to contact the opposite blade assembly an act as a pivot stop to prevent further closing of the tin snip tool beyond a set position based on the extension length. In this regard, the adjustor member may be threaded and may be moved into position by turning the adjustor member to obtain the desired extension length. In this regard, based on the extension length of the adjustor member, a blade bypass angle may be defined with the pivot point of the tin snip tool blades being the vertex of the angle relative to the tips of the cutting edges of the blades. According to some example embodiments, the adjustor member may be set to an extension length where, when the tin snip tool is in the closed position (i.e., the blades are prevented from moving into a further bypass or overlapping position) the tips of the cutting edges of the blades do not bypass (or overlap), but are still in cutting contact with each other. This setting would have a blade bypass angle of zero degrees.

As such, through implementation of a blade bypass calibrator, according to some example embodiments, as further described herein, an ability to prevent overlapping of the blade tips of the tin snip tool and avoid the potential for bending or damaging the material that is being cut can be realized. Additionally, over time and usage of tin snip tools, blade bypass calibration may be lost, the cutting edges of the blades may wear, and other changes in the tool may occur. A blade bypass calibrator, according to some example embodiments, may provide for ongoing adjustment of the blade bypass or overlap, when in the closed position, over the lifetime of the tool.

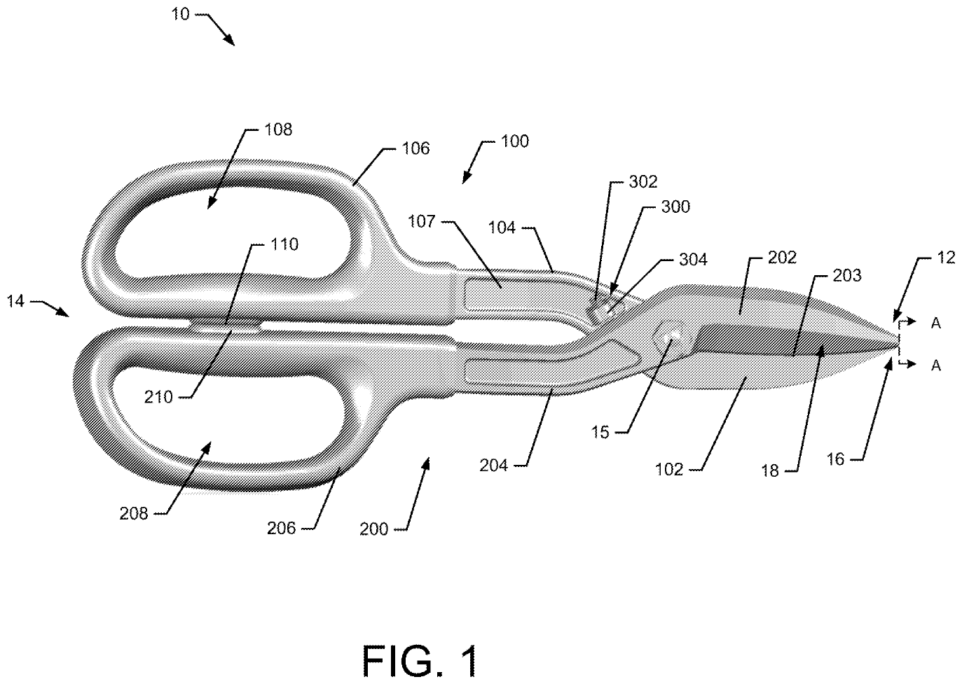

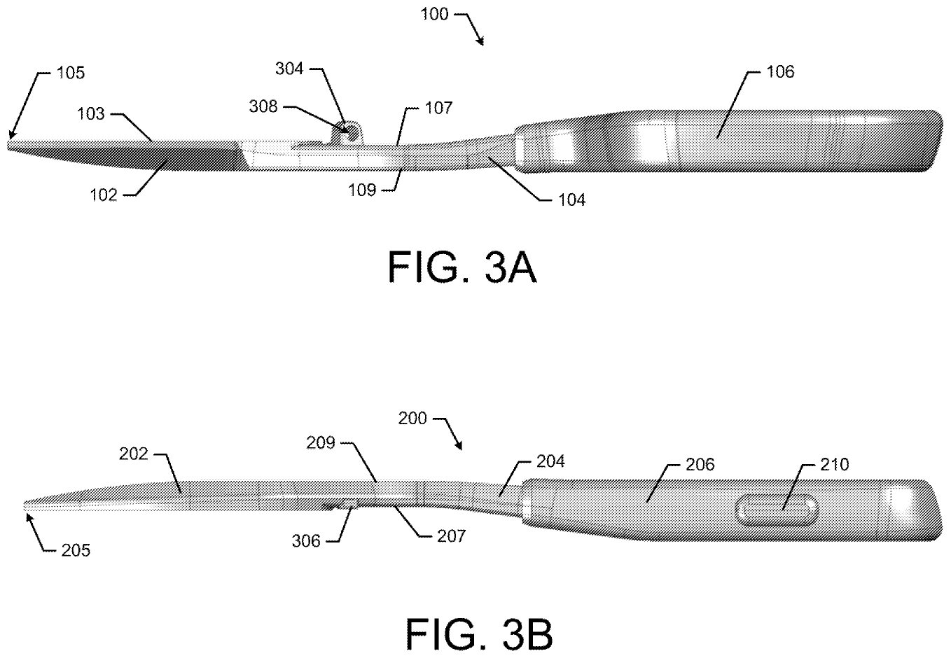

Accordingly, FIG. 1 illustrates a tin snip tool 10 comprising a blade bypass calibrator 300. The tin snip tool 10 may be a hand-held cutting tool with sharp edged members that pivot at a rotating connecting point and slide across each other such that the cutting edges meet at a forward moving point as a cutting operation performed. The tin snip tool 10 may have a forward end 12 and a rearward end 14, with a blade tip region 16 at the forward end 12. The first blade tip 105 (FIG. 3A) and the second blade tip 205 (FIG. 3B) may be disposed at the forward end 12 of the tin snip tool 10 in the blade tip region 16. In this regard, the tin snip tool 10 may comprise a first blade assembly 100 coupled to a second blade assembly 200 via a bolt 15.

The first blade assembly 100 may comprise a first blade 102 at the forward end 12, a first neck 104 coupled to the first blade 102 at a position rearward of the first blade 102, and a first handle 106 coupled to the first neck 104 at a position rearward of the first neck 104 and at the rearward end 14 of the tin snip tool 10. As such, according to some example embodiments, the first blade 102 may be coupled to the first handle 106 via the first neck 104. According to some example embodiments, the first blade assembly 100 may be a forged member (e.g., a steel forged member) as an integrated member that includes the first blade 102, the first neck 104, and the first handle 106. Alternatively, according to some example embodiments, the first blade 102 and the first neck 104 may be forged with an elongate portion extending rearward from the first neck 104 that couples to a separate, affixable first handle 106. In such example embodiments, the first handle 106 may be, for example, a slide-on component (e.g., formed of plastic or the like) that is affixed to the elongate portion. In this regard, the first handle 106 may include a first finger opening 108 configured to receive and secure a user's fingers or thumb for use while performing a cutting operation using the tin snip tool 10. Additionally, the first handle 106 may include a bump protrusion 110. The bump protrusion may be disposed on the first neck 104 or the first handle 106 and may be configured to prevent, for example, the large area of the first handle to contact the second handle 206 during use of the tin snip tool 10 that could cause a user's hand to be pinched therebetween.

The second blade assembly 200 may be constructed in a similar fashion to the first blade assembly 100, albeit in an inverted orientation. In this regard, the second blade assembly 200 may comprise a second blade 202 at the forward end 12, a second neck 204 coupled to the second blade 202 at a position rearward of the second blade 202, and a second handle 206 coupled to the second neck 204 at a position rearward of the second neck 204 and at the rearward end 14 of the tin snip tool 10. As such, according to some example embodiments, the second blade 202 may be coupled to the second handle 206 via the second neck 204. According to some example embodiments, the second blade assembly 200 may be forged (e.g., steel forged) as an integrated member that includes the second blade 202, the second neck 204, and the second handle 206. Alternatively, according to some example embodiments, the second blade 202 and the second neck 204 may be forged with an elongate portion extending rearward from the second neck 204 that couples to a separate, affixable second handle 206. In such example embodiments, second handle 206 may be, for example, a slide-on component (e.g., formed of plastic or the like) that is affixed to the elongate portion. In this regard, the second handle 206 may include a second finger opening 208 configured to receive and secure a user's fingers or thumb while the tin snip tool 10 is performing a cutting operation. Additionally, the second handle 206 may include a bump protrusion 210 that may correspond with the bump protrusion 110 to operate in the same manner as the bump protrusion 110.

As further described herein, a blade bypass calibrator 300 may be coupled to, for example, the first blade assembly 100. More specifically, according to some example embodiments, the blade bypass calibrator 300 may be coupled to an inner side wall 107 of the first neck 104 of the first blade assembly 100. According to some example embodiments, the blade bypass calibrator 300 may be disposed forward of the first handle 106 and rearward of the bolt 15. The blade bypass calibrator 300 may include a protrusion 304 comprising a channel 308 (see FIG. 3A) disposed therein and an adjustor member 302. The protrusion 304 may be coupled to the first blade assembly 100. The adjustor member 302 may be disposed in the channel 308 and configured to move within the channel 308. Further, according to some example embodiments, the adjustor member 302 may be coupled to the first neck 104 of the first blade assembly 100. The adjustor member 302 may be movable within the channel 308 to extend by an extension length out the channel 308 toward a surface of the second neck 204 (e.g., an upper surface of the second neck 204). According to some example embodiments, the extension length may be set by rotating the adjustor member 302. The adjustor member 302 may extend such that an end of the adjustor member 302 closest to the second blade assembly 200 may come into contact with the second blade assembly 200 to prevent further movement of the first blade assembly 100 relative to the second blade assembly 200 in a closing direction (i.e., in a direction such that the first blade 102 moves toward the second blade 202).

According to some example embodiments, the adjustor member 302 may contact the second neck 204 of the second blade assembly 200 when the tin snip tool 10 is in the closed position. As such, via adjustment of the adjustor member 302 within the channel 308 to extending out of the channel 308, the blade bypass calibrator 300 may operate to prevent the tin snip tool 10 from further closing the blades to control the amount of bypass between the first blade 102 and the second blade 202 when the tin snip tool 10 is in the closed position. Thus, the blade bypass calibrator 300 may comprise the movable adjustor member 302 coupled to the first blade assembly 100, and the adjustor member 302 may be configured to contact the second blade assembly 200 when the tin snip tool 10 is in a closed position.

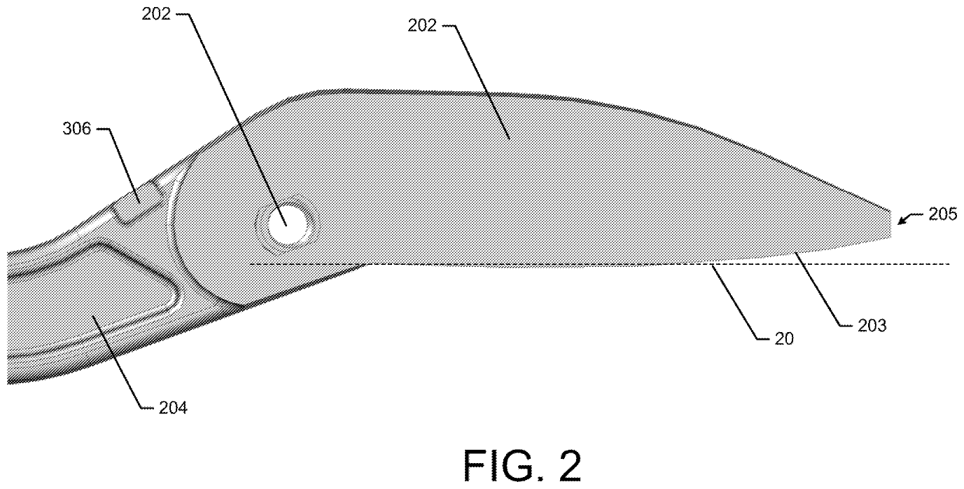

FIG. 2 illustrates a portion of the second blade assembly 200 including the second blade 202. The following provides a description of the architecture of the second blade 202 and other components noting that the first blade 102 of the first blade assembly 100 is similarly constructed in an inverted orientation.

In this regard, the second blade 202 may include a second blade tip 205, a second blade edge 203, and a bolt opening 204. The second blade 202 may include a planar blade surface that is machined or otherwise flattened to permit the first blade 102 to move smoothly across the planar blade surface while in contact when the tin snip tool 10 is cutting. The second blade tip 205 may be disposed at a forward end 12 of the second blade assembly 200. According to some example embodiments, the second blade tip 205 may come to a sharp point or may be somewhat blunted as shown in FIG. 2. The bolt opening 204 may be configured to align with a corresponding bolt opening in the first blade assembly 100 to receive a bolt 15 therethrough. The bolt 15 may operate to pivotally secure the second blade assembly 200 to the first blade assembly 100. In this regard, the bolt 15 may be configured to provide a pivot point that also couples the first blade assembly 100 to the second blade assembly 200 and permits at least a portion of the first blade 201 to bypass a portion of the second blade 202 during a cutting operation. According to some example embodiments, the bolt 15 may be secured within the bolt openings by a nut that is tightened onto the bolt 15 after being passed through the bolt openings.

The second blade edge 203 may be sharp to facilitate cutting. Additionally, the second blade edge 203 may have a non-linear cutting edge, such as a curved cutting edge. In this regard, the curved cutting edge of the second blade edge 203 may be appreciated with respect to the line 20 provided in FIG. 2, where the line 20 intersects with the rearmost point of the second blade edge 203. As shown, the second blade edge 203 may extend below the rearmost point before curving upward to the forward-most point of the second blade edge 203 at the second blade tip 205. The curved cutting edge of the second blade edge 203 may be defined, for example, such that, as a cutting operation is performed, the forces applied by the second blade edge 203, in cooperation with the first blade edge 103, are applied normal to the surface of the material being cut throughout a single closing operation of the tin snip tool 10. Additionally, according to some example embodiments, the second blade edge 203 may be ground or smooth, or the second blade edge 203 may be serrated.

As mentioned above, the first blade 102 of the first blade assembly 100 may have a similar construction as that of the second blade 202 of FIG. 2. As such, the same or similar characteristics may be comprised by the first blade 102, albeit in an inverted orientation. For example, the first blade 102 and the second blade 202 may each include curved cutting edges as described above. Further, the first blade 102 or the second blade 202 may have a ground or smoother cutting edge or a serrated cutting edge.

FIGS. 3A and 3B illustrate top views of the first blade assembly 100 and the second blade assembly 200 respectively to further describe components of the blade bypass calibrator 300, according to some example embodiments. More particularly, in FIG. 3A, a top view of the first blade assembly 100 in isolation is provided, and FIG. 3B, a top view of the second blade assembly 200 in isolation is provided.

In this regard, as shown in FIG. 3A, the protrusion 304 may extend away from the inner side wall 107 of the first neck 104 and away from the outer side wall 109. The protrusion 304 may be a forged or molded protrusion of the first blade assembly 100 (e.g., forged or molded into the first neck 104). Additionally, with reference to the second blade assembly 200 in FIG. 3B, the protrusion 304 may extend away from the inner side wall 107 in a manner that overlaps a top surface of the second neck 204 of the second blade assembly 200.

In this regard, according to some example embodiments, the second blade assembly 200 may include a landing 306 that may engage with the adjustor member 302 as the tin snip tool 10 is moved into the closed position. In this regard, the landing 306 may be a flat profiled area on the second neck 204 that is configured to receive and make robust contact with the extended end of the adjustor member 302. According to some example embodiments, the landing 306 may be disposed on the inner side wall 207 of the second neck 204, opposite the outer side wall 209 of the second neck 204.

When assembled, the inner face of the first blade 102 may be in contact with the inner face of the second blade 202. Because, as described above, the inner faces of the first blade 102 and second blade 202 are smooth and planar, the first blade 102 may engage with the second blade 202 along a plane, which may be referred to as the cutting plane. Further, because the channel 308 of the protrusion 304 is angled relative to the cutting plane, the adjustor member 302 may move in a direction is not orthogonal to a plane that is orthogonal to the cutting plane.

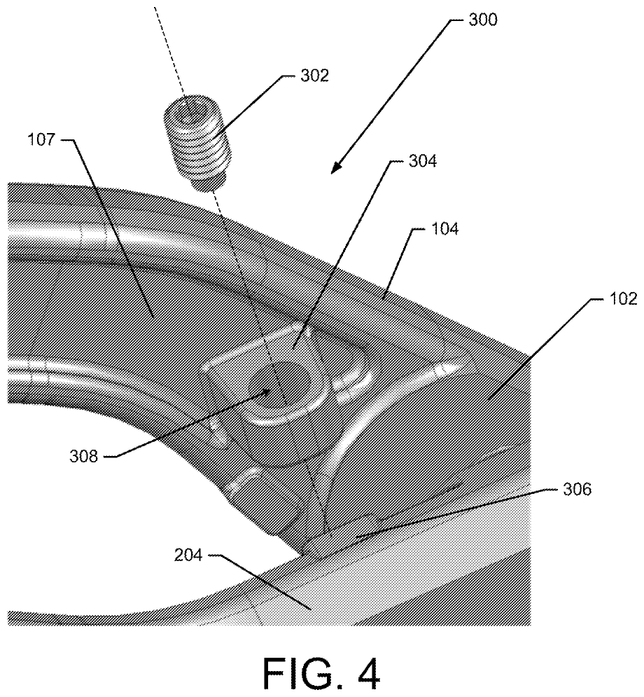

Now, with reference to FIG. 4, a more detailed, zoomed view of the blade bypass calibrator 300, according to some example embodiments, is provided. As shown in the FIG. 4, the first neck 104 and the second neck 204 are in an assembled position with the bolt 15 in place. The adjustor member 302 is shown as being a substantially, cylindrical member. According to some example embodiments, the adjustor member 302 may include screw threading, for example, around an exterior of the body of the adjustor member 302. The adjustor member 302 may also include a driver receptacle at a first end of the adjustor member 302. According to some example embodiments, the driver receptacle may be configured to receive, for example, an Allen wrench, screwdriver, or the like to allow for rotating the adjustor member 302 using a driving tool. The adjustor member 302 may also include a contact stud at a second end (opposite the first end) of the adjustor member 302. The contact stud may be configured to extend towards the landing 306 and may contact the landing 306 when the tin snip tool 10 is in the closed position.

The channel 308 may also include complementary screw threading on an internal surface of the channel 308. In this regard, the protrusion 304, as a forged or molded component that is integrated with the first neck 104, may be machined on an internal surface to form the screw threading. As the adjustor member 302 is rotated in a first direction, the adjustor member 302 may increasingly extend out the channel 308 by an extension length towards the second blade assembly 200 and the landing 306. As the adjustor member 302 is rotated in a second direction (opposite the first direction), the adjustor member 302 may increasingly retract into the channel 308 and away from the second blade assembly 200 and the landing 306. According to some example embodiments, the extension length of the adjustor member 302 may define a blade bypass angle (as further described below) defined between the first blade tip and the second blade tip when the tin snip tool 10 is in the closed position.

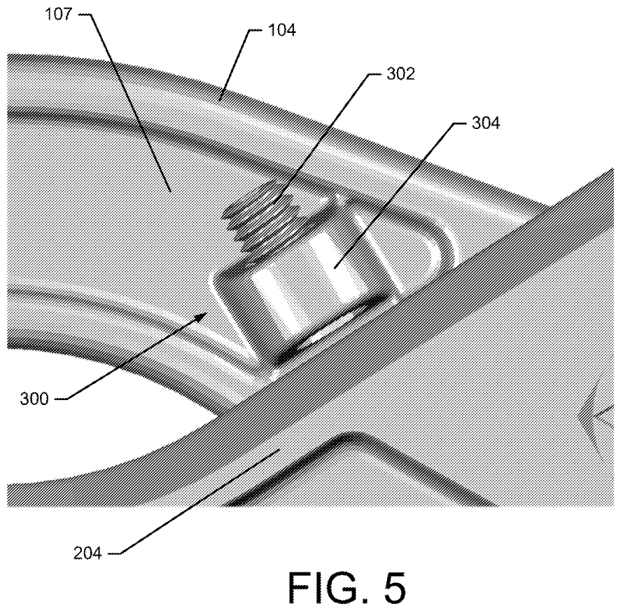

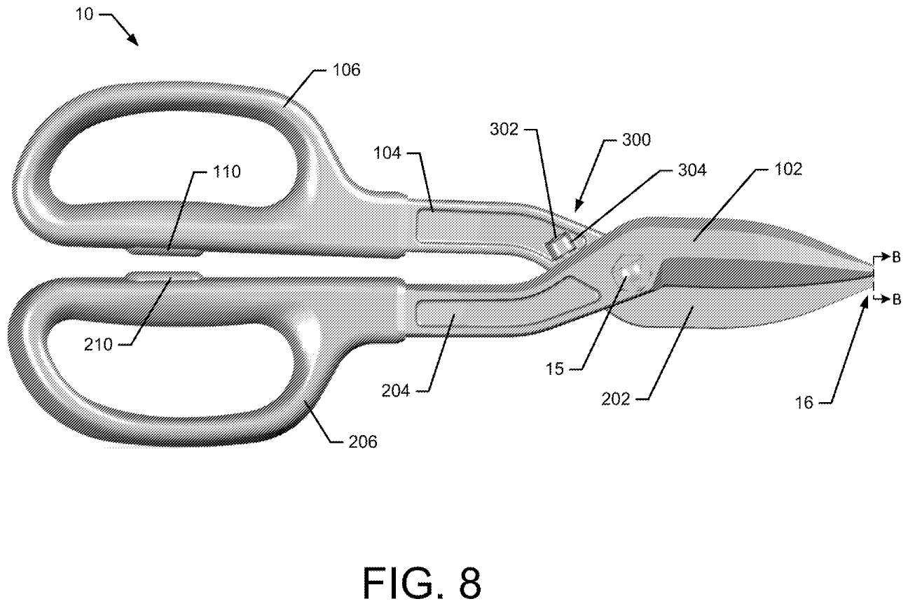

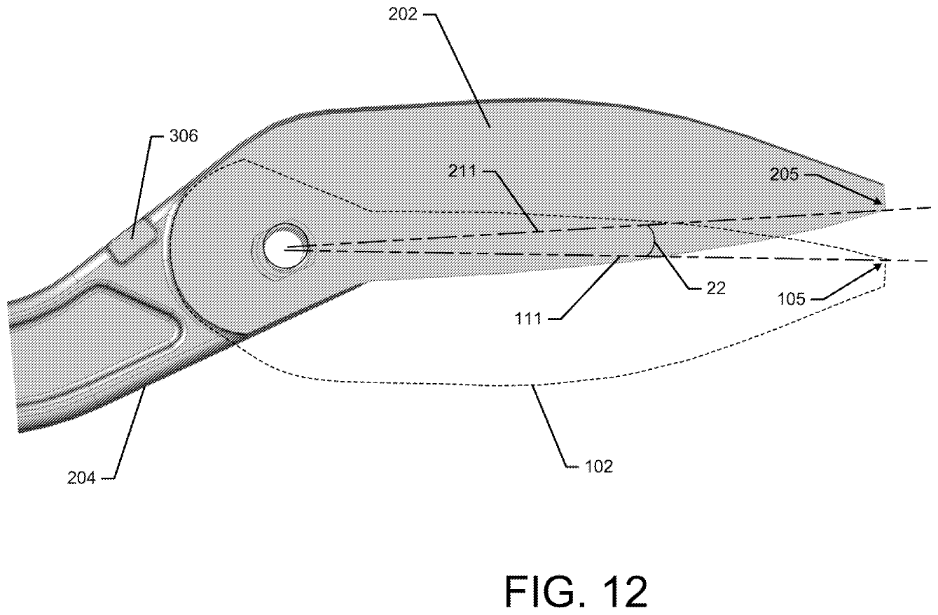

Having described the construction of the blade bypass calibrator 300, according to some example embodiments, FIGS. 5 to 7 will now be described which illustrate the blade bypass calibrator 300 with the adjustor member 302 in a retracted position that allows for maximum bypass or overlap of the blades (i.e., a largest blade bypass angle). Subsequently, FIGS. 8 to 11 will be described which show the blade bypass calibrator 300 with the adjustor member 302 in an extended position that causes the first blade tip 105 and the second blade tip 205 to have no overlap or bypass, but still be in cutting contact (i.e., a zero-degree blade bypass angle). Finally, FIG. 12 will be described which shows the first blade 102 and the second blade 202 in positions associated with larger extension length and defining a negative blade bypass angle.

In this regard, with reference to FIG. 5, a detailed, zoomed-in view of the blade bypass calibrator 300 is shown with the adjustor member 302 in a retracted position (i.e., not extending out of the channel 308 in the protrusion 340). As such, the extension length of the adjustor member 302 as shown in FIG. 5 is zero. As such, when the tin snip tool 10 is moved into the closed position, the adjustor member 302 does not contact the second neck 204 and the landing 306 because the adjustor member 302 is retracted. Accordingly, the first blade tip 105 and the second blade tip 205 may have maximum overlap with the adjustor member 302 in the retracted position.

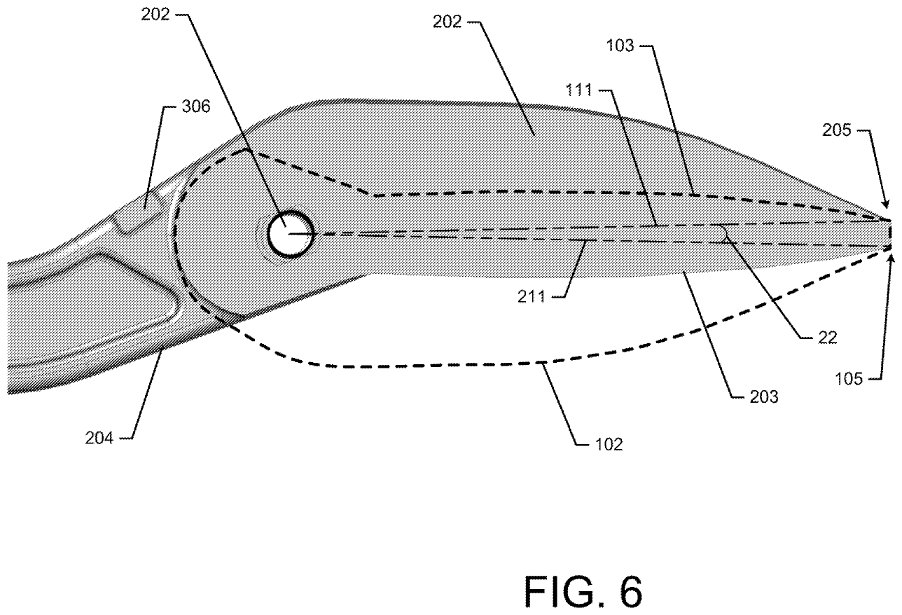

In this regard, FIG. 6 shows the second blade 202 with an outline of the first blade 102, when the tin snip tool 10 is in the closed position and the adjustor member 302 is in a retracted position (as shown in FIG. 5). The outline of the first blade 102 is shown in dotted lines to more easily depict the relative positions of the first blade 102 and the second blade 202 and the overlap between the first blade 102 and the second blade 202 when the tin snip tool 10 is in the closed position. As such, the blade bypass angle 22 can be defined with the center of the bolt opening 202 being the vertex, a first line 111 from the center of the bolt opening 202 to the first blade tip 105 (or, more specifically, to the forward-most point on the first cutting edge 103), and a second line 211 from the center of the bolt opening 202 to the second blade tip 205 (or, more specifically, to the forward-most point on the first cutting edge 203). As can be seen in FIG. 6, a positive blade bypass angle 22 is defined due to the overlapped positions of the first blade tip 105 and the second blade tip 205 when the tin snip tool 10 is in the closed position and the adjustor member 302 is in a retracted position.

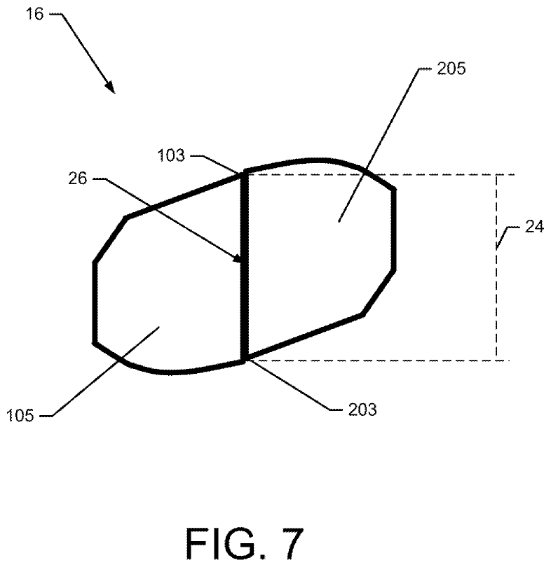

To more clearly describe the relative positions of the first blade tip 105 and the second blade tip 205, FIG. 7 shows a front view of the blade tip region 16 taken at A-A in FIG. 1. Note that in FIG. 1, the tin snip tool 10 is in the closed position and the adjustor member 302 is in the retracted position. In this regard, it can be seen in FIG. 7, that the first blade tip 105 maximally overlaps with the second blade tip 205 at engagement region 26, such that the first blade edge 103 and the second blade edge 203 have bypassed each other and continued to move into a position where the blade edges are disposed at opposite ends of the engagement region 26. As such, the overlap length 24 may be equal to the height of the first blade tip 105 or the second blade tip 205 due to the blunted tips, according to some example embodiments. The degree of overlap shown in FIG. 7 is the type that can cause damage and bending to the material being cut because the material forward of the tips is forced apart, with no cutting edge, by the overlapping tips 105 and 205.

Now with reference to FIG. 8, the tin snip tool 10 is shown, according to some example embodiments, in the closed position with the adjustor member 302 in an extended position. In this regard, the adjustor member 302 may have been turned (e.g., via an Allen wrench) to adjust the extension length of the adjustor member 302 in the direction towards the second blade assembly 200. Due to the extended position of the adjustor member 302, when the tin snip tool 10 is moved in a closing direction (i.e., the blades are moving together to overlap for cutting) the adjustor member 302 eventually contacts the landing 306 and stops the relative movement of the blades 102 and 202 to establish a different closed position. It can be seen in FIG. 8 (relative to FIG. 1) that bump protrusions 110 and 210 can no longer contact each other (as indicated by the gap therebetween) because the extended position of the adjustor member 302 prevents the first blade assembly 100 and the second blade assembly 200 from further rotating in the closing direction. As such, contact between the adjustor member 302 and the second blade assembly 200 when the tin snip tool 10 is in the closed position prevents any contact between the first handle 106 of the first blade assembly 100 with the second handle 206 of the second blade assembly 200.

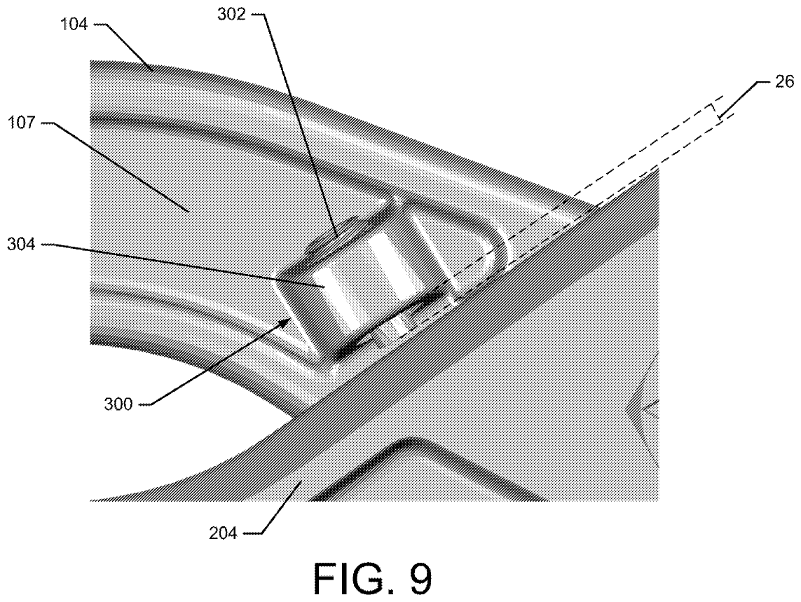

With reference to FIG. 9, a detailed, zoomed-in view of the blade bypass calibrator 300 is shown with the adjustor member 302 in an extended position. In this regard, it can be seen that the adjustor member 302 has been moved into an extended position where the extension length 26 (i.e., the distance between the base of the protrusion 304 and the extended end of the adjustor member 302) is greater than zero. When the tin snip tool 10 is moved into the closed position, the adjustor member 302 contacts the second neck 204 and the landing 306 (prior to the bump protrusions 110 and 210 contacting) because the adjustor member 302 is extended. Further, according to some example embodiments, the adjustor member 302 is positioned such that the extension length 26 results in no overlap of the first blade tip 105 and the second blade tip 205 (i.e., a zero-degree blade bypass angle 22). As such, the first blade tip 105 and the second blade tip 205 may have no overlap, but may still be in cutting contact with each other, while the adjustor member 302 in the extended position shown in FIG. 9.

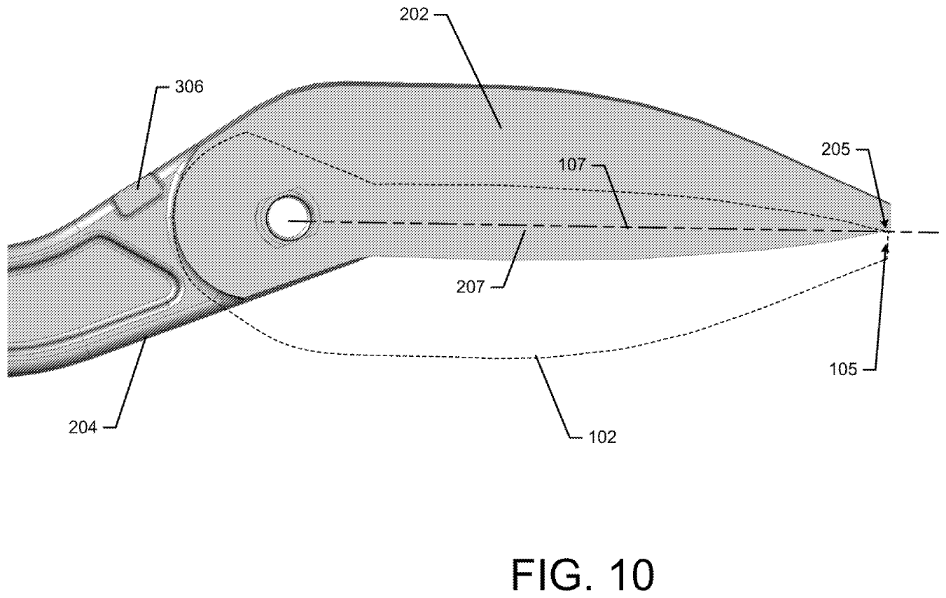

In this regard, FIG. 10 shows the second blade 202 with an outline of the first blade 102, when the tin snip tool 10 is in the closed position and the adjustor member 302 is in the extended position as shown in FIG. 9. The outline of the first blade 102 is shown in dotted lines to more easily depict the relative positions of the first blade 102 and the second blade 202, and the overlap between the first blade 102 and the second blade 202, when the tin snip tool 10 is in the closed position. As such, the blade bypass angle 22 (as previously defined) is zero degrees, because the lines 107 and 207 are identical and the first blade tip 105 does not overlap the second blade tip 205 while still being in cutting contact and otherwise maximizing the overlap area of the first blade 102 and the second blade 202.

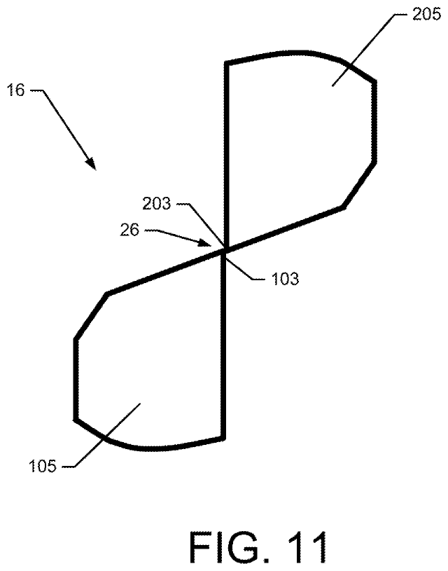

To more clearly describe the relative positions of the first blade tip 105 and the second blade tip 205, FIG. 11 shows a front view of the blade tip region 16 taken at B-B in FIG. 8. In this regard, it can be seen in FIG. 11, that the first blade tip 105 does not overlap with the second blade tip 205 and the engagement region 26 has a zero area. As such, the first blade tip 105 does not overlap the second blade tip 205 thereby preventing a user from closing the tin snip tool 10 beyond this minimal engagement of the first blade tip 105 and the second blade tip 205 to avoid damaging and bending to the material being cut as described above. Thus, the adjustor member 302 may be positionable such that the extension length 26 defines a blade bypass angle 26 where the first blade tip 105 does not overlap the second blade tip 205.

Now referring to FIG. 12, an example embodiment is shown where the adjustor member 302 is extended even further (i.e., having a larger extension length 26, beyond the zero tip overlap position shown in FIGS. 8-11). In this regard, the example embodiment of FIG. 12 shows the tin snip tool 10 in the closed position where the extension length of the adjustor member 302 prevent any contact between the first blade tip 105 and the second blade tip 205. As such, the blade bypass angle 22 is a negative angle since the line 211 is now above the line 111 (in comparison with the respective positions in FIG. 6).

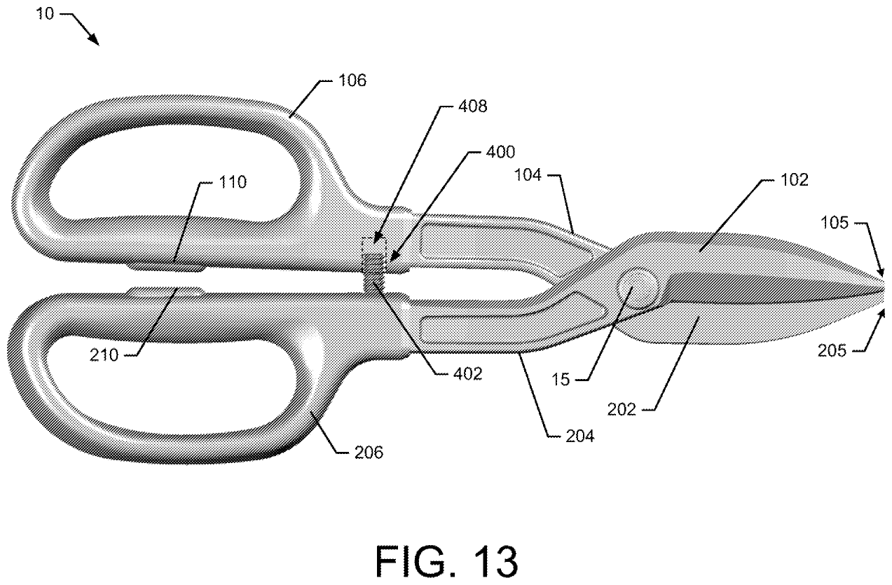

Further, FIG. 13 illustrates the tin snip tool 10 with another example embodiment of a blade bypass calibrator, as blade bypass calibrator 400. In this regard, rather than being disposed on the inner side wall 107 of the first neck 104, the blade bypass calibrator 400 may be disposed in between a bottom side of the first handle 106 and a top side of the second handle 206. Alternatively, according to some example embodiments, the blade bypass calibrator 400 may be disposed in between a bottom side of the first neck 104 and a top side of the second neck 204.

In this regard, according to some example embodiments, an adjustor member 402 may be disposed in a channel 408 formed in the first handle 106 (or first neck 104). As such, the channel 408, of the blade bypass calibrator 400 may be formed in the first blade assembly 100. The adjustor member 402 may be movable within the channel 408, for example, via external screw threading in engagement with corresponding internal screw threading in the channel 408. As a result, rotation of the adjustor member 402 in a first direction may retract the adjustor member 402 into the channel 408 to increase the blade bypass angle (as defined above) or rotation of the adjustor member 402 in a second direction (opposite to the first direction) may extend the adjustor member 402 to increase the extension length and reduce the blade bypass angle (as defined above). When the tin snip tool 10 are moved into the closed position the lower end of the adjustor member 402 may contact the top side (or upper wall) of the second handle 206 thereby preventing further overlapping of the first blade tip 105 and the second blade tip 205.

As such, according to some example embodiments, an example tin snip tool is provided that may comprise a first blade assembly comprising a first blade having a first blade tip, second blade assembly comprising a second blade having a second blade tip, a bolt configured to provide a pivot point that couples the first blade assembly to the second blade assembly and permits at least a portion of the first blade to bypass a portion of the second blade during a cutting operation, and a blade bypass calibrator comprising a movable adjustor member coupled to the first blade assembly and configured to contact the second blade assembly when the tin snip tool is in a closed position. An extension length of the adjustor member may define a blade bypass angle defined between the first blade tip and the second blade tip when the tin snip tool is in the closed position.

Additionally, according to some example embodiments, the adjustor member may be positionable such that the extension length defines a blade bypass angle where the first blade tip does not overlap the second blade tip. Additionally or alternatively, the first blade or the second blade may include a curved cutting edge. Additionally or alternatively, the first blade or the second blade may include a serrated cutting edge. Additionally or alternatively, the adjustor member may include screw threading, and the extension length may be set by rotating the adjustor member. Additionally or alternatively, the first blade assembly may further comprise a first neck and a first handle. In this regard, the first blade may be coupled to the first handle via the first neck, and the adjustor member may be coupled to the first neck of the first blade assembly. Additionally or alternatively, the second blade assembly may further comprise a second neck and a second handle. In this regard, the second blade may be coupled to the second handle via the second neck, and the adjustor member may contact the second neck of the second blade assembly when the tin snip tool is in the closed position. Additionally or alternatively, the blade bypass calibrator may further comprise a protrusion coupled to the first blade assembly, and the protrusion may comprises a channel. In this regard, the adjustor member may be configured to move within the channel. Additionally or alternatively, the first blade assembly may be a forged member and the protrusion may be a forged protrusion of the first blade assembly. Additionally or alternatively, the blade bypass calibrator may further comprise a channel formed in the first blade assembly, and the adjustor member may be configured to move within the channel.

According to some example embodiments, another example tin snip tool may comprise a first blade assembly comprising a first blade having a first blade tip disposed at a forward end of the tin snip tool and a first handle disposed at a rearward end of the tin snip tool, a second blade assembly comprising a second blade having a second blade tip disposed at the forward end of the tin snip tool and a second handle disposed at the rearward end of the tin snip tool, a bolt configured to provide a pivot point that couples the first blade assembly to the second blade assembly and permits at least a portion of the first blade to bypass a portion of the second blade during a cutting operation, and a blade bypass calibrator comprising a movable adjustor member. The blade bypass calibrator may be disposed forward of the first handle and reward of the bolt, and the adjustor member may be coupled to the first blade assembly and configured to contact the second blade assembly when the tin snip tool is in a closed position. An extension length of the adjustor member may define a blade bypass angle defined between the first blade tip and the second blade tip when the tin snip tool is in the closed position.

Additionally, the blade bypass calibrator may further comprise a protrusion coupled to the first blade assembly. The protrusion may comprise a channel, and the adjustor member may be configured to move within the channel. Additionally or alternatively, the protrusion may extend from a side wall of the first blade assembly, and the adjustor member may contact a landing on an upper wall of the second blade assembly. The first blade may engage with the second blade along a cutting plane, and the protrusion may intersect the cutting plane. Additionally or alternatively, the contact between the adjustor member and the second blade assembly when the tin snip tool is in the closed position may prevent any contact between the first handle of the first blade assembly with the second handle of the second blade assembly. Additionally or alternatively, the adjustor member may be positionable such that the extension length defines a blade bypass angle where the first blade tip does not overlap the second blade tip. Additionally or alternatively, the adjustor member may include screw threading, and the extension length may be set by rotating the adjustor member. Additionally or alternatively, the first blade assembly may further comprise a first neck, and the first blade may be coupled to the first handle via the first neck. In this regard, the adjustor member may be coupled to the first neck of the first blade assembly. Additionally or alternatively, the second blade assembly may further comprise a second neck, and the second blade may be coupled to the second handle via the second neck. In this regard, the adjustor member may contact the second neck of the second blade assembly when the tin snip tool is in the closed position. Additionally or alternatively, the first blade may engage with the second blade along a cutting plane, and the adjustor member may move in a direction that is not orthogonal to a plane that is orthogonal to the cutting plane.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A tin snip tool comprising:
a first blade assembly comprising a first blade having a first blade tip;
a second blade assembly comprising a second blade having a second blade tip;
a bolt configured to provide a pivot point that couples the first blade assembly to the second blade assembly and permits at least a portion of the first blade to bypass a portion of the second blade during a cutting operation; and
a blade bypass calibrator comprising a movable adjustor member coupled to the first blade assembly and configured to contact the second blade assembly when the tin snip tool is in a closed position, wherein an extension length of the adjustor member defines a blade bypass angle defined between the first blade tip and the second blade tip when the tin snip tool is in the closed position.

2. The tin snip tool of claim 1, wherein the adjustor member is positionable such that the extension length defines a blade bypass angle where the first blade tip does not overlap the second blade tip.

3. The tin snip tool of claim 1, wherein the first blade or the second blade includes a curved cutting edge.

4. The tin snip tool of claim 1, wherein the first blade or the second blade includes a serrated cutting edge.

5. The tin snip tool of claim 1, wherein the adjustor member includes screw threading, and wherein the extension length is set by rotating the adjustor member.

6. The tin snip tool of claim 1, wherein the first blade assembly further comprises a first neck and a first handle, wherein the first blade is coupled to the first handle via the first neck;
wherein the adjustor member is coupled to the first neck of the first blade assembly.

7. The tin snip tool of claim 6, wherein the second blade assembly further comprises a second neck and a second handle, wherein the second blade is coupled to the second handle via the second neck;
wherein the adjustor member contacts the second neck of the second blade assembly when the tin snip tool is in the closed position.

8. The tin snip tool of claim 1 wherein the blade bypass calibrator further comprises a protrusion coupled to the first blade assembly;
wherein the protrusion comprises a channel; and
wherein the adjustor member is configured to move within the channel.

9. The tin snip of claim 8 wherein the first blade assembly is a forged member and wherein the protrusion is a forged protrusion of the first blade assembly.

10. The tin snip of claim 1, wherein the blade bypass calibrator further comprises a channel formed in the first blade assembly;
wherein the adjustor member is configured to move within the channel.

11. A tin snip tool comprising:
a first blade assembly comprising a first blade having a first blade tip disposed at a forward end of the tin snip tool and a first handle disposed at a rearward end of the tin snip tool;
a second blade assembly comprising a second blade having a second blade tip disposed at the forward end of the tin snip tool and a second handle disposed at the rearward end of the tin snip tool;
a bolt configured to provide a pivot point that couples the first blade assembly to the second blade assembly and permits at least a portion of the first blade to bypass a portion of the second blade during a cutting operation; and
a blade bypass calibrator comprising a movable adjustor member, the blade bypass calibrator being disposed forward of the first handle and reward of the bolt, the adjustor member being coupled to the first blade assembly and configured to contact the second blade assembly when the tin snip tool is in a closed position, wherein an extension length of the adjustor member defines a blade bypass angle defined between the first blade tip and the second blade tip when the tin snip tool is in the closed position.

12. The tin snip tool of claim 11 wherein the blade bypass calibrator further comprises a protrusion coupled to the first blade assembly;
wherein the protrusion comprises a channel; and
wherein the adjustor member is configured to move within the channel.

13. The tin snip tool of claim 12 wherein the protrusion extends from a side wall of the first blade assembly;
wherein the adjustor member contacts a landing on an upper wall of the second blade assembly;
wherein the first blade engages with the second blade along a cutting plane; and
wherein the protrusion intersects the cutting plane.

14. The tin snip of claim 11, wherein the contact between the adjustor member and the second blade assembly when the tin snip tool is in the closed position prevents any contact between the first handle of the first blade assembly with the second handle of the second blade assembly.

15. The tin snip tool of claim 11, wherein the adjustor member is positionable such that the extension length defines a blade bypass angle where the first blade tip does not overlap the second blade tip.

16. The tin snip tool of claim 11, wherein the adjustor member includes screw threading, and wherein the extension length is set by rotating the adjustor member.

17. The tin snip tool of claim 11, wherein the first blade assembly further comprises a first neck, wherein the first blade is coupled to the first handle via the first neck;
wherein the adjustor member is coupled to the first neck of the first blade assembly.

18. The tin snip tool of claim 17, wherein the second blade assembly further comprises a second neck, wherein the second blade is coupled to the second handle via the second neck;
wherein the adjustor member contacts the second neck of the second blade assembly when the tin snip tool is in the closed position.

20. The tin snip of claim 11, wherein the first blade engages with the second blade along a cutting plane; and
wherein the adjustor member moves in a direction that is not orthogonal to a plane that is orthogonal to the cutting plane.
